(19) United States
(12) Patent Application Publication
(10) Pub. No.: US 2015/0224830 A1
(43) Pub. Date: Aug. 13, 2015

(54) Tire-Pressure Monitoring Device

(71) Applicant: Hsin-Chieh Chen, Taichung City (TW)

(72) Inventor: Hsin-Chieh Chen, Taichung City (TW)

(21) Appl. No.: 14/277,907

(22) Filed: May 15, 2014

(30) Foreign Application Priority Data
Feb. 12, 2014 (TW) 103202426

(51) Int. Cl. B60C 23/04

(52) U.S. Cl. CPC B60C 23/0433

(57) ABSTRACT

A tire-pressure monitoring device includes a detecting unit that detects tire pressure information of a tire for outputting a detection signal, a signal processing unit that includes a modulator block and a mixer block to process the detection signal so as to selectively output one of a first band output having a frequency within a first frequency band, and a second band output having a frequency within a second frequency band, an antenna, and an impedance matching network coupled between the signal processing unit and the antenna. The impedance matching network is configured such that an output impedance of the signal processing unit and an input impedance of the antenna are matched.

### CROSS-REFERENCE TO RELATED APPLICATION

This application claims priority to Taiwanese Application No. 103202426, filed on Feb. 12, 2014.

### BACKGROUND OF THE INVENTION

1. Field of the Invention

The invention relates to a monitoring device, and more particularly to a tire-pressure monitoring device.

2. Description of the Related Art

When a vehicle is running, insufficient tire pressure or over inflation of a tire may accelerate wear of the tire and cause danger during driving. The insufficient tire pressure may result in great tire deformation and the tire may overheat, thereby increasing rolling resistance and accelerating wear of the tire. Over inflation of the tire may result in poor tire traction and generate irregular wear. It is very important in traffic safety to monitor whether or not the tire pressure is maintained to be within a normal range, and a tire-pressure monitoring device has now become a standard equipment of a vehicle.

While the frequency bands used for receivers of tire-pressure monitoring systems include 315 MHz and 433 MHz frequency bands, the conventional tire-pressure monitoring devices are produced for only one of the 315 MHz and 433 MHz frequency bands, causing inconvenience in production.

### SUMMARY OF THE INVENTION

Therefore, an object of the present invention is to provide a tire-pressure monitoring device that is operable to select a desired frequency band for signal transmission.

According to the present invention, a tire-pressure monitoring device comprises:

a detecting unit configured to detect tire pressure information of a tire, and to output a detection signal associated with the tire pressure information;

a signal processing unit coupled to the detecting unit for receiving the detection signal, and including a modulator block and a mixer block that cooperate to process the detection signal, so as to selectively output one of a first band output having a frequency within a first frequency band, and a second band output having a frequency within a second frequency band;

an impedance matching network coupled to the signal processing unit for receiving the one of the first band output and the second band output therefrom; and

an antenna coupled to the impedance matching network for receiving the one of the first band output and the second band output therefrom, and configured to wirelessly transmit the one of the first band output and the second band output.

The impedance matching network is configured such that an output impedance of the signal processing unit and an input impedance of the antenna are matched.

### BRIEF DESCRIPTION OF THE DRAWING

Other features and advantages of the present invention will become apparent in the following detailed description of the preferred embodiment with reference to the accompanying drawing, of which:

FIG. 1 is a block diagram illustrating a preferred embodiment of the tire-pressure monitoring device according to the present invention.

### DETAILED DESCRIPTION OF THE PREFERRED EMBODIMENT

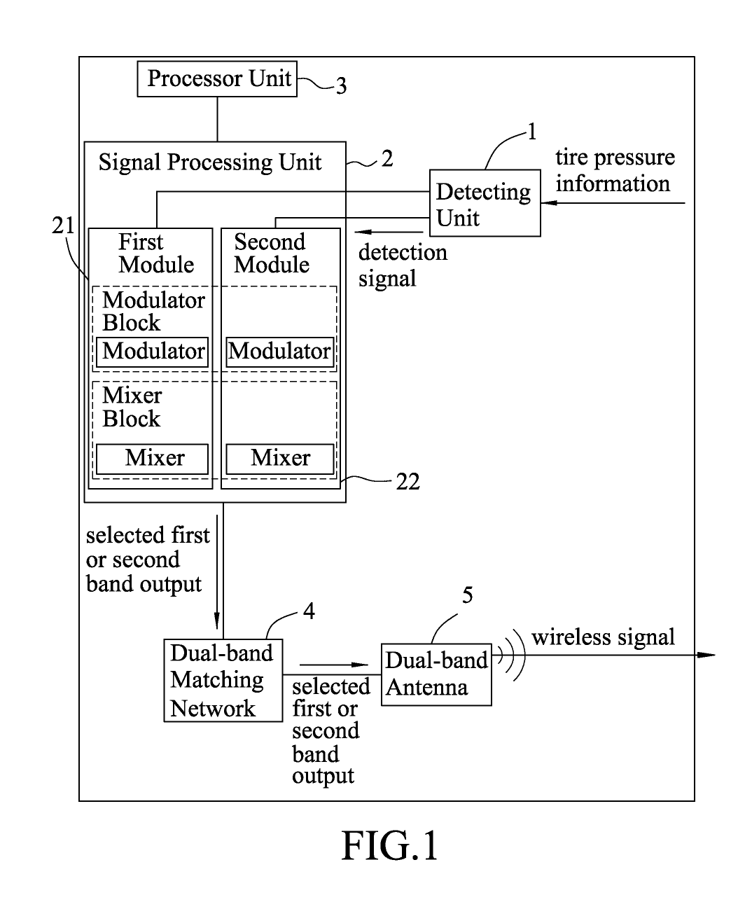

Referring to FIG. 1, the preferred embodiment of the tire-pressure monitoring device according to this invention is disposed on a tire of a vehicle, and includes a detecting unit 1, a signal processing unit 2, a processor unit 3, a dual-band matching network 4 (i.e., an impedance matching network) and a dual-band antenna 5. The tire-pressure monitoring device is operable in a first frequency band and a second frequency band, so as to reduce cost of production.

The detecting unit 1 is configured to detect tire pressure information of the tire, and to output a detection signal associated with the tire pressure information.

The signal processing unit 2 includes a first module 21 and a second module 22, each of which is coupled to the detecting unit 1 for receiving the detection signal.

The first module 21 includes a modulator and a mixer that cooperate to process the detection signal to generate a first band output having a frequency within a first frequency band. The second module 22 includes a modulator and a mixer that cooperate to process the detection signal to generate a second band output having a frequency within a second frequency band. The signal processing unit 2 is operable to select one of the first module 21 and the second module 22 to process the detection signal, so as to selectively output one of the first band output and the second band output. In this embodiment, the first frequency band has a resonance frequency of 315 MHz, and the second frequency band has a resonance frequency of 433 MHz.

The processor unit 3 is coupled to the signal processing unit 2, and controls the signal processing unit 2 to select one of the first module 21 and the second module 22 to process the detection signal for outputting a selected one of the first and second band outputs. In this embodiment, the processor unit 3 may be written with a program code to control the signal processing unit 2 to output the first band output with the frequency of 315 MHz or the second band output with the frequency of 433 MHz.

The dual-band matching network 4 is coupled to the signal processing unit 2 for receiving the selected one of the first band output and the second band output therefrom. The dual-band matching network 4 is configured such that an output impedance of the signal processing unit 2 and an input impedance of the dual-band antenna 5 are matched in both of the first frequency band and the second frequency band. As a result, either one of the first and second band outputs may not be consumed or reflected during transmission to the dual-band antenna 5.

The dual-band antenna 5 is coupled to the dual-band matching network 4 for receiving the selected one of the first and second band outputs therefrom, and is configured to wirelessly transmit the selected one of the first and second band outputs for receipt by a receiver installed in the vehicle. The dual-band antenna 5 is configured to output a wireless signal at either one of the first frequency band and the second frequency band. By virtue of the dual-band matching network 4, good impedance matching of the preferred embodiment may benefit wireless transmission by the dual-band antenna 5.

In production, the same process may be employed to manufacture the tire-pressure monitoring device of this invention for use in the first frequency band and in the second frequency band, thereby facilitating production and reducing manufacturing costs. Then, selection of the first and second band outputs to be outputted by the signal processing unit 2 may be configured using the processor unit 3.

In application, the program code of the processor unit 3 may be updated after production of the tire-pressure monitoring device to select output of the first band output or the second band output, thereby facilitating use of the tire-pressure monitoring device according to the present invention.

In use, the tire-pressure monitoring device is installed on the tire of the vehicle, and the frequency band in which the tire-pressure monitoring device operates should be selected to be the same as the frequency band in which the receiver of the vehicle operates, that is, one of the first band output and the second band output whose frequency band corresponds to the frequency band in which the receiver of the vehicle operates should be selected. The detecting unit 1 continuously detects the tire information, such as a pressure and a temperature within the tire, and outputs the detection signal. The signal processing unit 2 includes the modulators (i.e., a modulator block) and the mixers (i.e., a mixer block) to receive and process the detection signal, and outputs to the dual-band antenna 5 the selected one of the first and second band outputs through the dual-band matching network 4. The dual-band antenna 5 receives and wirelessly transmits the selected one of the first and second band outputs. Finally, the receiver wirelessly receives the selected one of the first and second band outputs transmitted by the dual-band antenna 5, so that the driver of the vehicle maybe aware of whether or not the tire pressure is normal.

To sum up, the tire-pressure monitoring device according to the present invention uses the signal processing unit 2 to selectively output one of the first band output, which has the frequency within the first frequency band, and the second band output, which has the frequency within the second frequency band, and uses the dual-band matching network 4 and the dual-band antenna 5 that are suitable for use in the first and second frequency bands, so that it is not necessary to manufacture the tire-pressure monitoring devices with different designs for use in different frequency bands, thereby facilitating manufacturing process and reducing manufacturing costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A tire-pressure monitoring device comprising:
a detecting unit configured to detect tire pressure information of a tire, and to output a detection signal associated with the tire pressure information;
a signal processing unit coupled to said detecting unit for receiving the detection signal, and including a modulator block and a mixer block that cooperate to process the detection signal, so as to selectively output one of a first band output having a frequency within a first frequency band, and a second band output having a frequency within a second frequency band;
an impedance matching network coupled to said signal processing unit for receiving said one of the first band output and the second band output therefrom; and
an antenna coupled to said impedance matching network for receiving said one of the first band output and the second band output therefrom, and configured to wirelessly transmit said one of the first band output and the second band output,
wherein said impedance matching network is configured such that an output impedance of said signal processing unit and an input impedance of said antenna are matched.

2. The tire-pressure monitoring device as claimed in claim 1, further comprising a processor unit coupled to said signal processing unit, and configured to control said signal processing unit to select one of the first band output and the second band output for output.

3. The tire-pressure monitoring device as claimed in claim 1, wherein the first frequency band has a resonance frequency of 315 MHz.

4. The tire-pressure monitoring device as claimed in claim 1, wherein the second frequency band has a resonance frequency of 433 MHz.

5. The tire-pressure monitoring device as claimed in claim 1, wherein said antenna is a dual-band antenna configured to output a wireless signal at either one of the first frequency band and the second frequency band.

6. The tire-pressure monitoring device as claimed in claim 1, wherein said impedance matching network is a dual-band matching network configured such that the output impedance of said signal processing unit and the input impedance of said antenna are matched in both of the first frequency band and the second frequency band.
